(19) United States
(12) Patent Application Publication
(10) Pub. No.: US 2004/0262878 A1
(43) Pub. Date: Dec. 30, 2004

(54) Lever enhanced pedaling system

(76) Inventor: Rashad N. Scarborough, Durham, NC (US)

Correspondence Address: Rashad N. Scarborough, 1108 W. Cornwallis Rd # D, Durham, NC, 27705, US

(21) Appl. No.: 10/825,369

(22) Filed: Apr. 16, 2004

Related U.S. Application Data
(60) Provisional application No. 60/463,010, filed on Apr. 16, 2003.

(51) Int. Cl. B62M 5/00

(52) U.S. Cl. 280/253

(57) ABSTRACT

The Lever Enhanced Pedaling System is a symmetrical assembly of components founded on a rear frame of a vehicle, which holds two horizontal shafts, parallel to the length of the frame, with one shaft being directly above the other positioned below the level of the seat. Each horizontal shaft occupies one metal flat linear plate (32) through its flat surface centrally, providing it with pivotal ability at this connection. The adjacent ends of the two plates share a vertical connection to the upper portion of their own vertical beam (34) member with pivotal ability at this connection. These connections are adapted to provide both vertical beams (34) with a slight curved vertical movement, while the beams are 90 degrees and parallel to each other. These parallel connections (22) provide the means for each lever (2), connected to the lower end of their vertical beam member (34), to swing up and down in a reciprocating motion. Both levers (2) are adapted to be pressed down from a pedal (30) connected to their leading outer ends, while pivoting on their connection to the frame of the vehicle, which is located near the very rear of the this frame behind the axle of the vehicle's wheel. Each lever (2) is provided with means to pull down their own chain (14) member connected to their own chain slide fastening apparatus (6), fastened with sliding ability within the chain slide groove (26) of their member lever (2). Each chain (14) is arranged to interact with their own members of sprockets, which includes a stationary sprocket (10), central sprocket (12) connected to the wheel of vehicle and sprocket with vertical movement ability (8). Each sprocket has a connection to the frame of the vehicle, with means of rotational interaction in the direction of their chain (14) member's movement, as both chains are pulled in a reciprocal motion. The downward pull of each chain rotates the central sprocket (12) against the rear wheel to turn and roll the vehicle forward. The Lever Enhanced Pedaling System has a system providing the means to change the ratio of rear wheel revolutions per pedal.

### BACKGROUND—FIELD OF INVENTION

This invention relates to pedaling systems or mechanisms that make bicycle pedaling performance easier and more efficient while riding bicycles.

### BACKGROUND—DESCRIPTION OF PRIOR ART

Bicycle retail shops, discount retail stores and web pages selling bicycles, all have illustrated or marketed bicycles that have significantly improved the efficiency of all bicycle components except the levers of their pedaling systems. Although there have been some bicycle inventions that have had compound rotary pedaling systems or electric aided pedaling systems, there has not been a simple nonrotary pedaling system that has exploited the laws of the simple machine of the lever and fulcrum. The Lever Enhanced Pedaling System (L.E.P.S.) offers the bicyclist a bicycle that takes less leg strength to pedal compared to conventional bicycles of different classes.

Based of the physical laws of the lever and fulcrum, if two objects having the same weight are on opposite ends of a lever, the object having the fulcrum farthest away from it will be pulled down by gravity to or below the level of the fulcrum. Similarly, the L.E.P.S. (FIG. 2) has its fulcrum at the end of its lever near the very rear part of the bicycle. At the opposite end of this fulcrum is the pedal. Between both is the sprocket connected to the axle of the rear wheel, which is fixed to turn forward against this axle and freely in the opposite direction. This sprocket is significantly closer to the fulcrum than it is to the pedal, thus allowing less force to be applied in rotating this sprocket in the forward direction when the pedal is pushed down. This form of lever and fulcrum combination is similar to a manually operated nutcracker, whereby the closer you place the nut to the fulcrum, the easier it is to crack the nut. Similarly, the L.E.P.S.'s sprocket that is apart of the axle to the rear wheel is significantly closer to the fulcrum than it is to the pedal, thus significantly providing a small amount of force needed to rotate the rear wheel forward. Consequently, the L.E.P.S. will take less leg strength to pedal forward bicycles, than conventional rotary pedal bicycles because the lever used to pedal the bicycle using the L.E.P.S. is longer than conventional bicycles with rotary pedaling systems. This pedaling also gives the bicyclist a longer pedaling range to achieve a longer stride when pushing the pedal downward. The position of the stationary point 6 where the chain around the three sprockets meet (FIG. 2) has a significantly long range of movement from its maximum height to its lowest level of depression, thus providing a wide ratio of this distance to the sprockets circumference and allowing the chain interacting with this sprocket to rotate the rear wheel completely, at least twice, from one complete downward push of the pedal. This gives the operator of the L.E.P.S. an advantage over the operators of bicycles having conventional rotary pedaling systems, because the operator of the L.E.P.S. would have to use less muscular movement for producing a greater number of rear wheel revolutions per pedal. These rear wheel revolutions per pedal could also be increased by simply sliding the chain 14 that is fastened to the chain lock 6 within the chain slide groove 26 of the lever toward the pedal 30, thus widening the ratio of the curve distance the chain 14 has to travel to the circumference of the central sprocket 12 connected to the axle of the rear wheel. This gives the operator of the L.E.P.S. longer strides when pedaling, while still exploiting the laws of the lever and fulcrum. These revolutions of rear wheel per pedal could be increased or decreased depending on the operator's choice of either increasing his speed while riding on a level plain or reducing the force needed to roll up steep inclines.

### OBJECTS AND ADVANTAGES

According, besides the objects and advantages of the L.E.P.S. described in my above patent, several objects and advantages of the present invention are:

(a) to provide a bicycle pedaling system with a mechanism to change the number of rear wheel revolutions per downward pedal;

(b) to provide a bicycle speed control system that is free from chain derailment during chain movement distance to sprocket circumference ratio change;

(c) to provide a Lever Enhanced Pedaling System that lets the bicyclist exploit his weight and gravity in order to pedal the bicycle forward.

### DRAWING FIGURES

FIG. 1 shows the complete right side of the bicycle having as its propelling component the Lever Enhanced Pedaling System.

FIG. 2 shows the right side of the bicycle with a breakaway section exposing the inner sprocket order and their relationship to the chain interacting with them. It also shows how the pulley configuration interacts with the chain lock 6 within the chain slide groove 26 of the lever for pulling the fastened section of the chain 14 towards the pedal. It further shows how the spring 16, connected to the lowest movable sprocket 8, interacts with the chain 14 to enable it to be pulled towards the pedal 30 and contracted back into its original position.

FIG. 3 shows shows an alternative embodiment of a lever repositioning system 31 of two sprockets 27, platform 29 and chain 33.

FIG. 4 shows an alternative embodiment of a lever repositioning system having tubes as levers and a small cylinder as a chain lock.

### REFERENCE NUMERALS IN DRAWINGS

| | |
|---|---|
| 2 lever | 16 spring |
| 4 fulcrum of lever | 18 spring/sprocket connector |
| repositioning system | |
| 6 chain lock | 20 sprocket groove |
| 8 movable sprocket | 22 lever repositioning system |
| 10 stationary sprocket | 24 wheel revolution per pedal control system |
| 12 central sprocket | 26 chain slide groove |
| 14 chain | 28 pulley wheel |
| 30 pedal | 34 vertical beams |
| 32 rectangular lever plate | 27 lever repositioning sprocket |
| 29 lever repositioning | 33 lever repositioning chain |
| platform | |

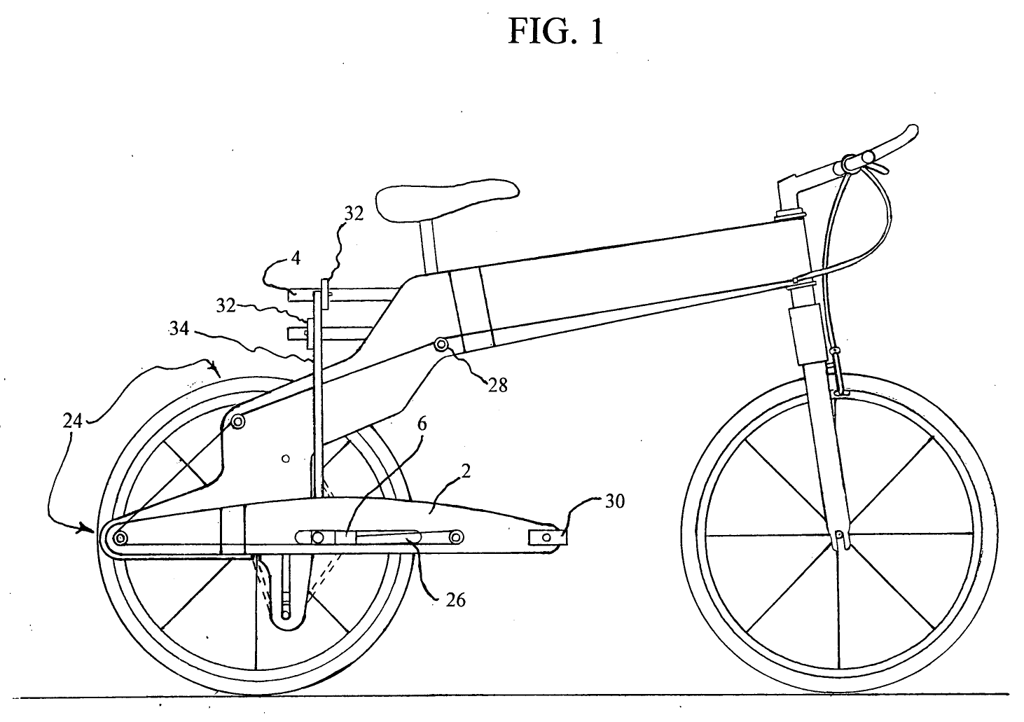

### DESCRIPTION—FIGS. 1,3, and 4

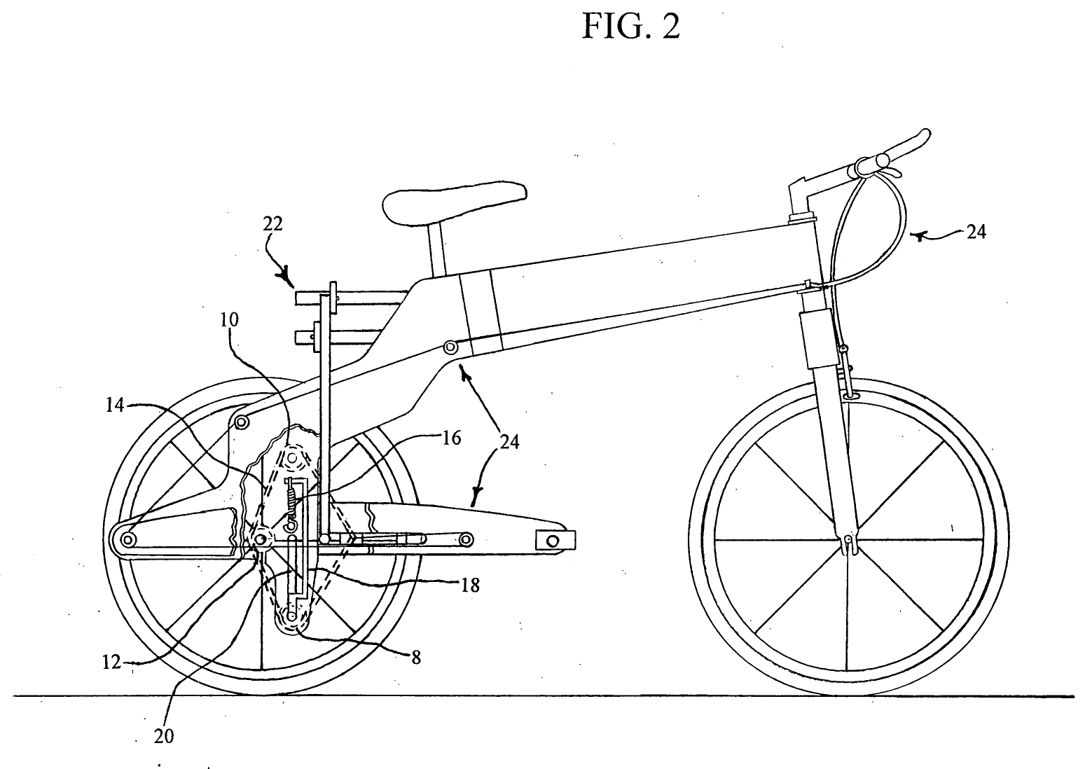

The total embodiment of the lever enhanced pedaling system (L.E.P. S.) is best represented in FIG. 1. The L.E.P.S. is a symmetrical assembly of components that interact with each other. The pedal 30 is connected to the lever 2 having pivotal ability at its connection. The lever 2 is about half the length of the entire bicycle. Its linear portion is arched upward for reinforcement. Near the levers 2 center to the outer circumference of the wheel is a chain slide groove 20 which is about ¾″ wide. Within the groove is the chain lock 6. The cord wrapped around the frontal curve of a pulley wheel 28, is fastened with pivotal ability to the lever 2 between the pedal 30 and chain slide groove 26. This cord is apart of a wheel revolution per pedal control system 24, which wraps around three other pulley wheels 28. One is located on the pivotal center of the lever 2, the second is located within the middle upper curve of the bicycle frame which is between the lever 2 and rim of the rear bicycle wheel. The third pulley wheel is located on the bicycle frame just under the base of the seat pole FIG. 1. Each pulley wheel 28 has pivotal ability and their outer curve surfaces part inward toward the center of their shafts forming an angle. These angles hold the cords of the wheel revolution per pedal control system 24 so that they don't slip off. The pivotal ability of the pulley wheel 28 decreases the friction of the cords movement when it is manually pulled by the rotation of the speed selector on the handle bar. The rear section of the lever 2 is bent in two areas to avoid conflict with the axle of the rear wheel. The rear section of the lever 2 is flat against a circular array of ball bearings, which is between the bicycle frame and lever 2. The ball bearings decrease friction between the two surfaces when the lever is pivoting up and down. The frontal section of the lever is further away from the surface of the bicycle frame avoiding collision with the axle of the rear wheel, and vertical beams 34 of the lever repositioning system 22. A pedal 30 is connected perpendicularly to the levers' leading flat surface with pivotal ability at this connection. The chain 14 is wrapped around the movable sprocket 8, central sprocket 12 and stationary sprocket 10 finally meeting together, being fastened to the chain lock 6. The spring 16 is connected to the spring/sprocket connector 18. The spring/sprocket connector 18 is a linear component (FIG. 2) formed to hold the upper hook of the spring 16, slide within the sprocket groove 20 and connect to the movable sprocket 8 with pivotal ability around the linear components' lower shaft. The sprocket groove 20 is vertical and linear. It is positioned between the central sprocket 12 and chain lock 6 (FIG. 2). The movable sprocket 8, stationary sprocket 10 and central sprocket 12 all have a pivotal connection to the bicycle frame.

The lever repositioning system 22 is composed of two fulcrums 4 shaped like shafts, which are welded between the walls of a bicycle frame. Connected to each shaft is a flat rectangular component 32 of Aluminum. Each shaft occupies the bore in the center of the Aluminum rectangular component 32. These pair of components 32 have symmetry and two bores through opposite ends of their flat surfaces. Occupying each pair of separate bores are the shafts of a linear vertical component 34 of the lever repositioning system 22 (L.R.S.). These linear components 34 are composed of Aluminum. Each is positioned between the flat surface ends of the rectangular levers 32 and have pivotal ability at this connection. The bottom ends of each vertical linear component 34 has a shaft extending perpendicularly away from the sides of the bicycle frame. These shafts extend through a chain slide groove 26. These shafts have the ability to slide within the groove in any direction.

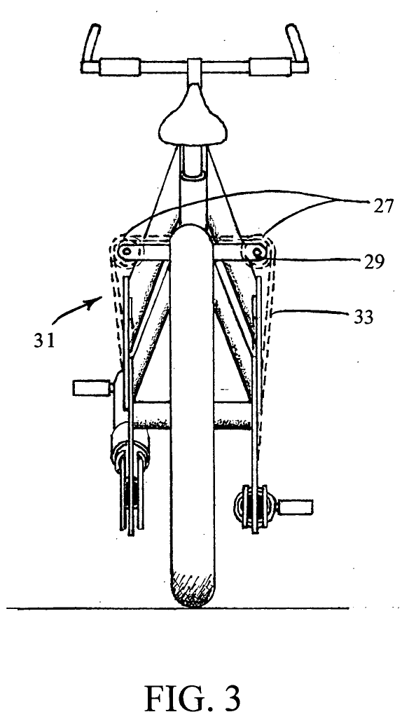

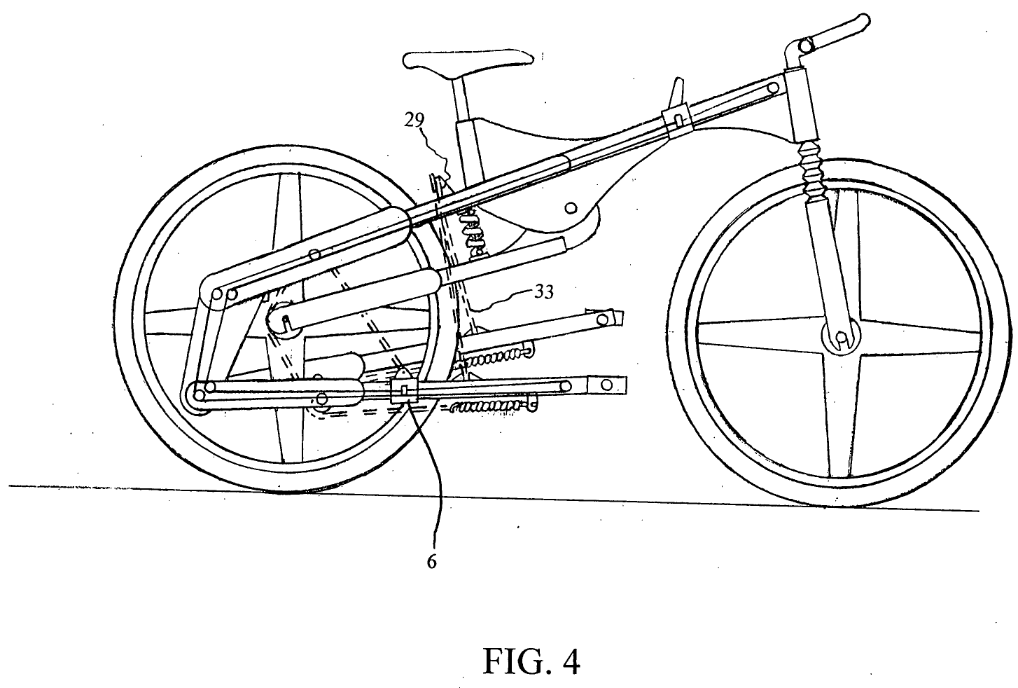

### OPERATION—FIGS. 3 TO 4

The lever enhanced pedaling system L.E.P.S. is designed to provide the advantages of the laws of the lever and fulcrum by allowing the operator of a bicycle having this system to propel his own weight on two wheels with as little amount of force as possible.

The L.E.P.S. is operated by pressing down on one pedal with one foot while resting the other foot on the other pedal, allowing the resting foot with no exerted pressure upon the pedal to be elevated to the pedals highest level or the operators desired level. Once this level is achieved, the operator will take the foot that is resting on the elevated pedal and press it downward to its lowest possible level or level desired by the operator. These steps must take place while the operator is balancing on the bicycle and repeated again to achieve a significant traveling distance. Once these steps are done and repeated, several mechanical reactions will take place:

The chain lock 6 will pull down the chain 14, which is fastened to it. This chain 14 will rotate the stationary sprocket 10 in the same direction of the wheels moving in a forward motion.

Furtherly, this chain from the stationary sprocket 10 will pull upward and rotate forward the central sprocket 12 that is connected to the axle of the rear wheel.

The central sprocket 12 will twist the axle of the rear wheel.

The axle connected to the rear wheel will turn the rear wheel in a forward direction, with the upper curve moving toward the front of the bicycle and its lower curve moving toward the back of the bicycle. This forward turn of the wheel will roll against the ground and move the bicycle forward.

Both rectangular plates 32, one above the other, will pivot centrally around separate shafts welded to the frame of the bike and lower vertically the vertical linear beams 34 connected between each plate 32 by shafts extruding from the linear beam's flat surfaces. This vertical linear beam connection is the same on the opposite end of the lever repositioning system, however the reaction is the opposite, resulting in the linear vertical beam lifting the lever 2 up with the shaft of the vertical beam 34 that is within the chain slide groove of the lever 2. Because both plates are positioned vertically with one above the other and their pivotal points are in a 90 degree line, their radial movements will be exactly the same and their pivotal connections to the vertical linear beams 34 will be exactly the same in a 90 degree line, thus only allowing the vertical beams to travel up or downward at a 90 degree angle. The movement of both vertical beams 34 will move up and downward in the same radial path as the center points of the shafts in the opposite bores in the plates 32 of the lever repositioning system 22. So during pedaling a bottom shaft of a linear vertical beam 34 will slide within the chain slide groove 26 of each lever 2 forwards, backwards, to the right and to the left. Each shaft connected to a linear beam 34 within a chain slide groove 26 will directly lift and lower a lever 2 repeatedly on each side for repetitive pedaling.

Whenever the operator chooses, he may pull the cords of wires around the pulley wheels to increase the revolutions of rear wheel per pedal or release the cords of wire by reversing the twist of the speed controllers on the handle bars to allow the spring pulling down of the movable sprocket to contract and pull the chain lock to a smaller radius of movement, thus decreasing the revolutions of rear wheel spin per downward pedal.

### SUMMARY, RAMIFICATIONS, AND SCOPE

Accordingly, the reader will recognize that the L.E.P.S. can be used as an alternative means of bicycle propulsion. That the force needed to propel the rider using such a system on a bicycle is reduced far below pedaling systems having conventional rotary devices and this system eliminates the problems of chain derailment during gear shifting on conventional rotary system because rear wheel revolution per pedal is changed by a secure linear movement of the chain of the L.E.P. S. Furthermore, the L.E.P.S. has additional advantages in that

it eliminates that chance of a riders garment being caught between the chain and main sprocket having a connection to the pedal;

it allows the rider to use his weight and gravity to propel himself forward on a bicycle having a L.E.P.S.;

because most of the componentry of the L.E.P.S. is located in the back of the bicycle, this arrangement makes capable a frame design that is of reduced weight and free from a polygonal shape.

The example of the L.E.P.S. presented is just one method of utilizing the laws of the lever and fulcrum in order to greatly reduce the amount of force needed to propel a bicyclist on a bicycle having a L.E.P.S. This specific model should not be considered the ultimate embodiment of the invention, but merely a mechanism presented to show the functional elements that allow the invention to work. For example, the L.E.P.S. could utilize a ratio of interacting gears, instead of sprockets and chains, to be used to change the number of rear wheel revolutions per pedal. Its pulley system used to change rear wheel revolutions per pedal could be replaced by simple holes through which the pull wires may pass through.

Thus, the scope of the invention should be determined by the independent claim and its dependents.

I claim:

1. A system with means of providing a small amount of pedaling force needed to propel a rider on a bicycle utilizing said system, which is composed of two fulcrum and lever machines with means to interact with each other in a reciprocal swinging motion.
